(19) United States
(12) Patent Application Publication
(10) Pub. No.: US 2018/0262134 A1
(43) Pub. Date: Sep. 13, 2018

(54) SWITCHED RELUCTANCE MOTOR MODELING METHOD

(71) Applicant: CHINA UNIVERSITY OF MINING AND TECHNOLOGY, Xuzhou, Jiangsu (CN)

(72) Inventors: Hao CHEN, Xuzhou, Jiangsu (CN); Yan LIANG, Xuzhou, Jiangsu (CN)

(21) Appl. No.: 15/573,840

(22) PCT Filed: Dec. 28, 2015
(86) PCT No.: PCT/CN2015/099096

§ 371 Date: Nov. 14, 2017

(30) Foreign Application Priority Data
May 15, 2015 (CN) 201510247960.2

(51) Int. Cl. H02P 6/34; H02P 25/08

(52) U.S. Cl. CPC H02P 6/34; H02P 25/08

(57) ABSTRACT

A switched reluctance motor modeling method, which is applicable to switched reluctance motors of various phase numbers. A variable resistor (RMp) formed by four operational amplifiers (U1, U2, U3, U4), three current conveyors (U5, U6, U7), a digital potentiometer and a digital controller, eight resistors (R1, R2, R3, R4, R5, Ro, Rx, Rs) and a capacitor (C) are adopted to form a switched reluctance motor phase winding equivalent model. The modeling method is simple, can realize system mathematic direct simulation for switched reluctance motors, and is capable of simulating and controlling in real time.

### FIELD OF THE INVENTION

The present invention relates to a modeling method for switched reluctance motor model, in particular to a modeling method for switched reluctance motor applicable to switched reluctance motors of various phase numbers.

### BACKGROUND ART

Switched reluctance motors are superior to conventional motor drive systems in terms of manufacturing cost, control flexibility, and fault tolerance capability, etc., owing to their unique double salient-poles structure and operation mode of independent excitation of each phases. However, the model of switched reluctance motor has high non-linearity and the mathematical expression is very complex, owing to the double salient-poles structure and magnetic saturation characteristic. At present, modeling methods for switched reluctance motors mainly include: calculating static magnetic flux linkage data of a motor through finite element computation of the motor magnetic field, and setting up a model in circuit emulation software through table look-up; the method involves a long computation time, occupies storage space heavily, and is difficult to be used for real-time simulation and real-time control; constructing a magnetic network, utilizing static magnetic flux linkage data of a motor obtained through magnetic circuit computation, and establishing a model in circuit emulation software through table look-up; with that method, on one hand, if a simple magnetic network is constructed, the established model of switched reluctance motor will be inaccurate; on the other hand, if a complex magnetic network is constructed, the universality of the established model of switched reluctance motor will be poor, and the magnetic circuit parameters have to be determined by experience, though the model of switched reluctance motor may be more accurate.

### CONTENTS OF THE INVENTION

To overcome the above-mentioned drawbacks in the prior art, the present invention provides a modeling method for a physical simulation model of switched reluctance motor system, which is simple, has high universality, realizes direct mathematical simulation of a switched reluctance motor system, and supports real-time simulation and real-time control.

To attain the technological object described above, the modeling method for switched reluctance motor according to the present invention is characterized in:

four operational amplifiers U1, U2, U3 and U4, three current conveyors U5, U6 and U7, a variable resistor R_{MP} composed of a digital potentiometer and a digital controller, eight resistors R1, R2, R3, R4, R5, R_{O}, R_{X} and R_{S}, and a capacitor C are used, the input ports are A and B respectively;

The modeling method comprises:

connecting the input port A with a non-inverting input port of the operational amplifier U1 and a port z of the current conveyor U₅ via the resistor R_{S} respectively, connecting the input port B with a port z of the current conveyor U6 and a port y of the current conveyor U7 respectively, connecting an output port 0 of the operational amplifier U1 with an inverting input port of the operational amplifier U1 and one port of the resistor R₁ respectively, connecting the other port of the resistor R₁ with an inverting input port of the operational amplifier U2 and one port of the resistor R₃ respectively, connecting an non-inverting input port of the operational amplifier U2 with one port of the resistor R₂ and one port of the resistor R₄ respectively, connecting the other port of the resistor R₄ to the ground, connecting the other port of the resistor R₂ with a port x of the current conveyor U7, connecting the output port 0 of the operational amplifier U2 with the other port of the resistor R₃ and one port of the resistor R₅ respectively, connecting the other port of the resistor R₅ with an inverting input port of the operational amplifier U3 and one port of the capacitor C respectively, connecting an non-inverting input port of the operational amplifier U₃ to the ground, connecting an inverting input port of the operational amplifier U3 with the other port of the capacitor C and a port F of the variable resistor R_{MP} respectively, connecting a port W of the variable resistor R_{MP} with one port of the resistor R_{O} and an inverting input port of the operational amplifier U4 respectively, denoting the instantaneous current value at the port W of the variable resistor R_{MP} as v_{sA} and the position signal at the port W of the variable resistor R_{MP} as θ_{A}, connecting the non-inverting input port of the operational amplifier U4 to the ground, connecting an output port 0 of the operational amplifier U₄ to the other port of the resistor R_{O} and a port y of the current conveyor U5 respectively, connecting a port x of the current conveyor U5 with a port x of the current conveyor U6 via the resistor R_{X}, connecting a port y of the current conveyor U6 to the ground, and connecting a port z of the current conveyor U7 to the ground;

the circuit model between the input port A and the input port B is equivalent to a circuit composed of the resistor R_{S} and the variable inductance L of the motor connected in series, so that an equivalent model of a switched reluctance motor phase winding is formed, wherein, the resistor R_{S} simulates the resistance of the switched reluctance motor phase winding, the variable inductance L simulates the inductance of the switched reluctance motor phase winding, which is a function of the rotor position and phase current of the motor; thus, a model of switched reluctance motor is obtained, and the variable inductance L is expressed as:

$$L ( i , θ ) = \frac{{R}_{X} {R}_{1} {R}_{5} C}{{R}_{3} {R}_{O}} {R}_{MP} ( i , θ )$$

wherein, R_{X}, R₁, R₅, R₃, R_{O} and R_{MP} are resistance values, C is capacitance value, and the resistance value of R_{MP} is a function of the instantaneous phase current value i and rotor position value θ of the motor.

The variable resistor R_{MP} comprises a digital potentiometer with ports F and W and a digital controller connected with the port W of the digital potentiometer, the model of digital potentiometer is AD5147, the model of digital controller is TMS320F28335, and the digital controller TMS320F28335 outputs a resistance control signal to control the resistance of the digital potentiometer AD5147 according to the instantaneous current signal V_{sA} and the position signal θ_{A} obtained by sampling.

Beneficial effects: The method according to the present invention employs operational amplifiers, current conveyors, a digital potentiometer, a digital controller, resistors, and a capacitor to set up a physical simulation model of switched reluctance motor. The method has high universality, can realize direct mathematical simulation, has high simulation accuracy, requires less computation time and less storage space. With the method, real-time simulation and real-time control of a switched reluctance motor system can be realized by adjusting the resistance value of the variable resistor and the inductance value, an optimal design of switched reluctance motor can be obtained, accurate quantitative analysis of static and dynamic system performance and control strategy evaluation can be accomplished; in addition, the method involves low cost and thereby eliminates the contradiction between cost and real-time feature of simulation of a switched reluctance motor system, sets a foundation for eliminating pulsations in the output torque of a switched reluctance motor system and position-sensorless real-time control, and has high theoretical value and wide industrial application prospects.

### DESCRIPTION OF THE DRAWINGS

FIG. 1 is a diagram of a physical simulation model of switched reluctance motor according to the present invention;

FIG. 2 is a schematic structural diagram of the variable resistor R_{MP} in the physical simulation model of switched reluctance motor according to the present invention;

FIG. 3 is an oscillogram of phase current and magnetic flux linkage of switched reluctance motor in the physical simulation model of switched reluctance motor according to the present invention.

### DETAILED DESCRIPTION OF THE EMBODIMENTS

Hereunder the present invention will be detailed in an embodiment with reference to the accompanying drawings.

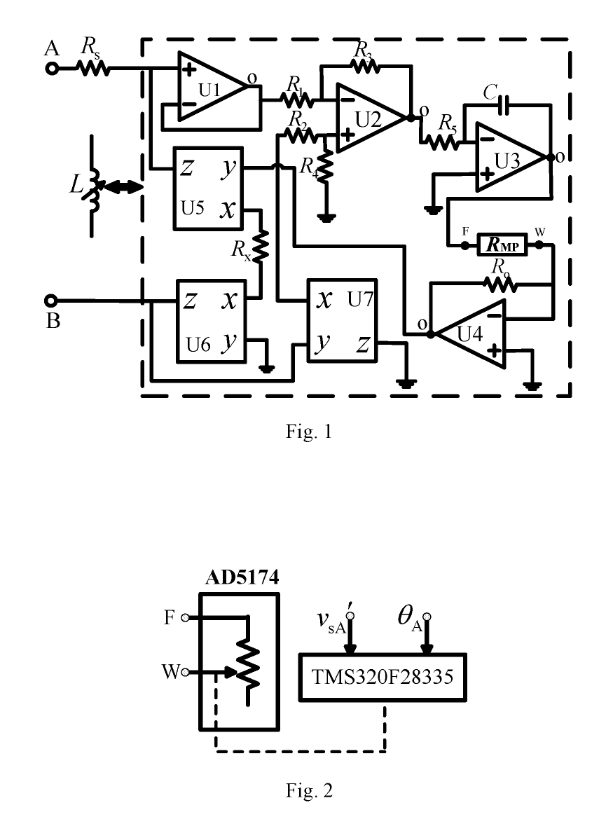

As shown in FIG. 1, the modeling method for switched reluctance motor according to the present invention uses four operational amplifiers U1, U2, U3 and U4, three current conveyors U5, U6 and U7, a variable resistor R_{MP} composed of a digital potentiometer and a digital controller, eight resistors R₁, R₂, R₃, R₄, R₅, R_{O}, R_{X} and R_{S}, and a capacitor C, the input ports are A and B respectively;

the modeling method comprises:

connecting the input port A with a non-inverting input port of the operational amplifier U1 and a port z of the current conveyor U5 via the resistor R_{S} respectively, connecting the input port B with a port z of the current conveyor U6 and a port y of the current conveyor U7 respectively, connecting an output port 0 of the operational amplifier U1 with an inverting input port of the operational amplifier U1 and one port of the resistor R1 respectively, connecting the other port of the resistor R1 with an inverting input port of the operational amplifier U2 and one port of the resistor R₃ respectively, connecting an non-inverting input port of the operational amplifier U2 with one port of the resistor R₂ and one port of the resistor R₄ respectively, connecting the other port of the resistor R₄ to the ground, connecting the other port of the resistor R₂ with a port x of the current conveyor U7, connecting the output port 0 of the operational amplifier U2 with the other port of the resistor R₃ and one port of the resistor R₅ respectively, connecting the other port of the resistor R₅ with an inverting input port of the operational amplifier U3 and one port of the capacitor C respectively, connecting an non-inverting input port of the operational amplifier U3 to the ground, connecting an inverting input port of the operational amplifier U3 with the other port of the capacitor C and a port F of the variable resistor R_{MP} respectively, connecting a port W of the variable resistor R_{MP} with one port of the resistor R_{O} and an inverting input port of the operational amplifier U4 respectively, denoting the instantaneous current value at the port W of the variable resistor R_{MP} as v_{sA} and the position signal at the port W of the variable resistor R_{MP} as θ_{A}, connecting the non-inverting input port of the operational amplifier U4 to the ground, connecting an output port 0 of the operational amplifier U4 to the other port of the resistor R_{O} and a port y of the current conveyor U5 respectively, connecting a port x of the current conveyor U5 with a port x of the current conveyor U6 via the resistor R_{X}, connecting a port y of the current conveyor U6 to the ground, and connecting a port z of the current conveyor U7 to the ground;

the circuit model between the input port A and the input port B is equivalent to a circuit composed of the resistor R_{S} and the variable inductance L of the motor connected in series, so that an equivalent model of a switched reluctance motor phase winding is formed, wherein, the resistor R_{S} simulates the resistance of the switched reluctance motor phase winding, the variable inductance L simulates the inductance of the switched reluctance motor phase winding, which is a function of the rotor position and phase current of the motor; thus, a model of switched reluctance motor is obtained, and the variable inductance L is expressed as:

$$L ( i , θ ) = \frac{{R}_{X} {R}_{1} {R}_{5} C}{{R}_{3} {R}_{O}} {R}_{MP} ( i , θ )$$

wherein, R_{X}, R₁, R₅, R₃, R_{O} and R_{MP} are resistance values, C is capacitance value, and the resistance value of R_{MP} is a function of the instantaneous phase current value i and rotor position value θ of the motor.

As shown in FIG. 2, the variable resistor R_{MP} comprises a digital potentiometer with ports F and W and a digital controller connected with the port W of the digital potentiometer, the model of digital potentiometer is AD5147, the model of digital controller is TMS320F28335, and the digital controller TMS320F28335 outputs a resistance control signal to control the resistance of the digital potentiometer AD5147 according to the instantaneous current signal v_{sA} and the position signal θ_{A} that are obtained by sampling.

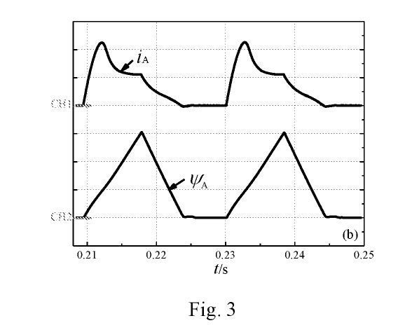

FIG. 3 is an oscillogram of phase current i_{A} and magnetic flux linkage Ψ_{A} of switched reluctance motor reproduced in the physical simulation model of switched reluctance motor according to the present invention, it is evident that the established physical simulation model of switched reluctance motor can realize direct mathematical simulation, has high simulation accuracy, requires less computation time and less storage space, eliminates the contradiction between cost and real-time feature of simulation of a switched reluctance motor system, and can realize real-time simulation and real-time control of a switched reluctance motor system, optimal design of switched reluctance motor, and accurate quantitative analysis of static and dynamic system performance and control strategy evaluation.

1. A switched reluctance motor modeling method, wherein,
four operational amplifiers U1, U2, U3 and U4, three current conveyors U5, U6 and U7, a variable resistor R_{MP} composed of a digital potentiometer and a digital controller, eight resistors R₁, R₂, R₃, R₄, R₅, R_{O}, R_{X} and R_{S}, and a capacitor C are used, the input ports are A and B respectively; the modeling method comprises:
connecting the input port A with a non-inverting input port of the operational amplifier U1 and a port z of the current conveyor U5 via the resistor R_{S} respectively, connecting the input port B with a port z of the current conveyor U6 and a port y of the current conveyor U7 respectively, connecting an output port 0 of the operational amplifier U1 with an inverting input port of the operational amplifier U1 and one port of the resistor R₁ respectively, connecting the other port of the resistor R₁ with an inverting input port of the operational amplifier U2 and one port of the resistor R₃ respectively, connecting an non-inverting input port of the operational amplifier U2 with one port of the resistor R₂ and one port of the resistor R₄ respectively, connecting the other port of the resistor R₄ to the ground, connecting the other port of the resistor R₂ with a port x of the current conveyor U7, connecting the output port 0 of the operational amplifier U2 with the other port of the resistor R₃ and one port of the resistor R₅ respectively, connecting the other port of the resistor R₅ with an inverting input port of the operational amplifier U3 and one port of the capacitor C respectively, connecting an non-inverting input port of the operational amplifier U3 to the ground, connecting an inverting input port of the operational amplifier U3 with the other port of the capacitor C and a port F of the variable resistor R_{MP} respectively, connecting a port W of the variable resistor R_{MP} with one port of the resistor R_{O} and an inverting input port of the operational amplifier U₄ respectively, denoting the instantaneous current value at the port W of the variable resistor R_{MP} as v_{sA} and the position signal at the port W of the variable resistor R_{MP} as θ_{A}, connecting the non-inverting input port of the operational amplifier U4 to the ground, connecting an output port 0 of the operational amplifier U4 to the other port of the resistor R_{O} and a port y of the current conveyor U5 respectively, connecting a port x of the current conveyor U5 with a port x of the current conveyor U6 via the resistor R_{X}, connecting a port y of the current conveyor U6 to the ground, and connecting a port z of the current conveyor U7 to the ground;
the circuit model between the input port A and the input port B is equivalent to a circuit composed of the resistor R_{S} and the variable inductance L of the motor connected in series, so that an equivalent model of a switched reluctance motor phase winding is formed, wherein, the resistor R_{S} simulates the resistance of the switched reluctance motor phase winding, the variable inductance L simulates the inductance of the switched reluctance motor phase winding, which is a function of the rotor position and phase current of the motor; thus, a model of switched reluctance motor is obtained, and the variable inductance L is expressed as:
$$L ( i , θ ) = \frac{{R}_{X} {R}_{1} {R}_{5} C}{{R}_{3} {R}_{O}} {R}_{MP} ( i , θ )$$
wherein, R_{X}, R₁, R₅, R₃, R_{O} and R_{MP} are resistance values, C is capacitance value, and the resistance value of R_{MP} is a function of the instantaneous phase current value i and rotor position value θ of the motor.

2. The switched reluctance motor modeling method according to claim 1, wherein, the variable resistor R_{MP} comprises a digital potentiometer with ports F and W and a digital controller connected with the port W of the digital potentiometer, the model of digital potentiometer is AD5147, the model of digital controller is TMS320F28335, and the digital controller TMS320F28335 outputs a resistance control signal to control the resistance of the digital potentiometer AD5147 according to the instantaneous current signal v_{sA} and the position signal θ_{A} that are obtained by sampling.
